(19) United States
(12) Patent Application Publication
(10) Pub. No.: US 2018/0162758 A1
(43) Pub. Date: Jun. 14, 2018

(54) Saline Water Desalination, Concentration, and Crystallization

(71) Applicant: Ben Harrison Cantrell, Springfield, VA (US)

(72) Inventor: Ben Harrison Cantrell, Springfield, VA (US)

(21) Appl. No.: 15/372,819

(22) Filed: Dec. 8, 2016

(51) Int. Cl. C02F 9/00; B01D 9/00

(52) U.S. Cl. CPC C02F 9/00; C02F 2103/08; B01D 9/00

(57) ABSTRACT

This invention obtains fresh water and only solid waste from input saline water. This result is commonly known as desalination having zero liquid discharge (ZLD). The current common means of ZLD desalination is to use any common desalination process such as distillation, reverse osmosis, electrodialysis, etc. followed by brine recovery and crystallization which are both based on evaporation of water processes. This invention provides an alternative to the commonly used brine recovery and crystallization processes to produce only solid waste. This invention has major components of (a) new ion concentration process, (b) combinations of prior art desalination processes and new ion concentration processes to produce fresh water and nearly saturated saline water from a saline water input, (c) another combination of prior art desalination and new ion concentration processes to produce fresh water and supersaturated saline water having a salinity in the metastable state zone from a nearly saturated saline water input, and (d) a separate process that precipitates out solids from the supersaturated saline water after seed crystals are introduced. The process also provides a means that prevents long-term buildup of precipitated solids in the ion concentration process that supersaturates the nearly saturated saline water input. The ion concentration process is composed of variations of prior art ion transfer processes where electrodialysis and capacitive deionization are examples.

### CROSS-REFERENCE TO RELATED APPLICATIONS

Not Applicable

### FEDERALLY SPONSORED RESEARCH OR DEVELOPMENT

Not applicable

### REFERENCE TO A “SEQUENCE LISTING”

Not Applicable

### NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

### Not Applicable

### BACKGROUND

### Field of the Invention

The field of this invention is to provide Zero Liquid Discharge ZLD (Solid Wastes) from desalination of saline water. Furthermore, ZLD operation is also often referred to as crystallization

### Description of the Related Art

Water significantly impacts the daily lives of each person on earth through its personal, industrial, and agricultural use. Water is loosely classified in this document as either “Fresh”, Saline, Contaminated Fresh, and Contaminated Saline Water. Fresh water is defined here as having acceptable levels of contaminants in the water for its use. Most fresh water is obtained through the “water cycle” by evaporating the water from the ocean and then depositing it over land as rain (fresh water). The rain waters the surface of the earth and the rest of it is temporally stored in streams, lakes, and replenished aquifers (Ground water). Some fresh water can be found in the polar ice caps and in non-replenished aquifers within the earth.

Saline water is defined as a water solution containing mostly dissolved salts that form electrolytes. Saline or Contaminated Saline water makes up most of earth's water and can be found in the oceans, streams (Especially streams near the ocean), and saline aquifers. Even with water conservation measures and improved means of better using the rain water, as the population grows there becomes a need to desalinate the abundant quantity of saline water to supplement earth's current fresh water supply.

Much of the source water on earth, that is considered fresh water and saline water, can be contaminated in a myriad of ways which is defined here as contaminated fresh water and contaminated saline water. Although some source water is directly usable or after desalination, much of it needs to be processed in some way to remove the contamination so as to provide useful water. In a general way, the myriad of contaminants in the water can be roughly divided into categories based on their size:
A. Macro Particle Size (>50 micrometer (μm)—Visible to Naked Eye)
B. Micro Particle Size (1 to 50 μm—Visible with Optical Microscope)
C. Macro Molecular Size (0.05 to 1 μm—Visible with Scanning Electron Microscope)
D. Molecular Size (0.001 to 0.05 μm—Visible with Scanning Electron Microscope)
E. Ionic Range Size (<0.001 μm=1 nm—Visible with Scanning Tunneling Microscope)

Based on size, contaminated fresh water is defined here as having any or all of the size range contaminants except for small quantities of Ionic Range Contaminants and fresh water as having only small quantities of any contaminants within acceptable limits. Based on size, saline water is defined here as only having solids dissolved in the water as ions with their size being in the Ionic Range Size as well as small quantities of other small contaminants suspended in the water. Contaminated saline water has any or all of the size range contaminants.

There are a number of water treatment process that will remove most of the water contaminants from the Macro Particle through the Molecular Sizes. Widely used water treatment processes, as described in numerous books and documents that remove Macro Particle through the Molecular Sizes contaminates from the water, are:
A. Grates/Screens—Removes macro particles
B. Coagulation/Flocculation/Clarification—Removes particulate (macro/micro) matter
C. Electro Coagulation—Removes particulate (macro/micro) matter
D. Granular Media (Sand, Diatomaceous Earth) Filtration—Removes suspended particles
E. Aeration/Air Stripping—Adds oxygen to the water and removes gases
F. Precipitative Softening—Chemical reactions removes “hard” water ions from the water
G. Ion Exchange—Exchanges one troublesome ion type for a not so troublesome ion type
H. Disinfection by using chlorine, ozone, or ultraviolet light—Kills microbial contamination
I. Active Carbon Filtering—Removes molecular size contaminants by adsorption
J. Biological Processes—Bacteria oxidizes and reduce many chemicals too be harmless
K. Membrane Filters
   Micro-filtration—Removes macro molecular size contaminates
   Ultra-filtration—Removes macro molecular and some molecular size contaminates
   Nano-filtration—Removes macro molecular through some ionic range size contaminates

The water treatment for contaminated saline water or just saline water must use desalination processes to remove the ionic sized ions from it. The most common widely used desalination processes which are described in numerous books and documents are distillation, reverse osmosis, and electrodialysis. Some desalination techniques remove contaminants other than just the ionic contaminants as well. Some desalination processes including the ones just mentioned are discussed in numerous books and documents and are listed:
A. Desalination by Removing Fresh Water from the Saline Feed Water: Widely used Examples are: Thermal Distillation and Reverse Osmosis Desalination
B. Desalination by Removing Contaminating Ions from the Saline Feed Water: Examples are: Electrodialysis in use, and Capacitive Deionization in development

For large volume flow rate desalination operations, all the desalination processes currently in wide use have large amounts of saline waste water or contaminated saline waste water. For desalination plants near the ocean, the waste water could be disposed of in the oceans although there are environmental issues to overcome. For inland desalination plants, the question is: What to do with the large quantities of saline waste water for large volume flow rate operations? The volume flow rate of waste water probably would be too large to discharge into the ground, streams, or evaporation ponds. Furthermore, many governmental entities are considering the requirement of nearly Zero Liquid Discharge ZLD which means the waste is required to be a solid (In our case mostly solid salts). These solid wastes then could be economically buried in the ground, transported to the ocean using bulk carriers (Rail or barge), or sold.

The technologies to reduce the saline waste water or contaminated saline waste water to a solid are usually found under the title of Zero Liquid Discharge ZLD or salt manufacturing. To obtain ZLD or to manufacture salt, crystallizers that form solids from the liquid are used. The crystallizers typically operate by removing water from the salt solution by evaporation until the ionic chemicals in the remaining solution becomes supersaturated and solid crystals precipitate out forming solids as described in Non-Patent Literature Document [1]. The common process today is a twostep processes of (a) Brine Recovery that removes some water by thermal evaporation followed by (b) Crystallization that removes almost all the water using a thermal evaporation process so solids are formed. There does not currently seem to be any crystallizers (Most processes today use thermal evaporation for crystallization) to form ZLD wastes that are satisfactory for large volume flow rates and for affordable costs.

An alternative method of desalination having Zero Liquid Discharge ZLD (solid) waste is to transfer ions from the input saline water into another separate saline water system until solids precipitate out. Variations of this basic process can be found in relatively new patent applications and patents found in U.S. Patent Documents [1], [2], [3], [4], and [5]. One of the underlying issues with these patent documents and with bringing this basic process to widespread use is for the process that transfers ions from the input saline water to the separate saline water to not become fouled as the separate water solution becomes heavily concentrated in ions which can cause a precipitation of solids within the ion transfer process itself. A portion of this invention will provide means for the separate highly concentrated saline water not to precipitate ions during the operation of the ion transfer process but yet will provide means for the highly concentrated saline water to precipitate out solids at a new location and at a different time.

This invention has major components of (a) ion concentration, (b) combinations of prior art desalination processes and ion concentration processes to produce fresh water and nearly saturated saline water from a saline water input, and (c) combinations of prior art desalination processes and ion concentration processes to produce fresh water and supersaturated saline water operating in the metastable zone from a nearly saturated saline water input which is converted to solids by precipitation in a separate process. As background, a few comments and a reference are provided on prior art that is relevant to this invention. These are:

A. Useful Properties of Distillation and Reverse Osmosis: Distillation and reverse osmosis divides a single input stream of saline feed water into a stream of lower salinity water and a stream of higher salinity water which is sometimes referred to as waste water. Often a number of desalination processes are operated in series where the reject water from one desalination process feeds the next desalination processes and the fresh water from all the desalination processes operated in series are combined. In some realizations, a portion of the higher salinity stream of water is recirculated and added to the input saline water stream.

B. Useful Property of Electrodialysis and Capacitive Deionization: Electrodialysis and capacitive deionization has two distinct separate water streams. By transferring ions from one saline water stream to the other, one water stream is made less saline and the other independent water stream is made more saline. This process can be called an ion transfer process. If the desired ion concentration is not reduced enough in a single pass of the ion transfer process, several ion transfer processes can be operated in series or the two saline waters can be recirculated through a single ion transfer process to obtain the desired low salinity output water for desalination. The performance of the ion transfer processes can be limited as the ratio of the salinities of the reject more saline output water to the desired less saline water becomes high.

C. Precipitation: In the chemistry of sparingly soluble salts; if a solid salt is added to water, the solid will disassociate and ions will distribute themselves throughout the water until the solution becomes saturated. After the solution becomes saturated with ions, if more solid salts are added to the solution, no more solid salt will dissolve and the saturated solution and the additional solid salt added to the solution past the solution saturation point will coexist in equilibrium. Actually, the amount of solid salt dissolving into the water is equal to the amount of salt precipitating out of the water to a solid when the solution is saturated. However, the solution can exist in an unstable supersaturated state where the concentrations of the salt is greater than the concentrations of the salt in the water when the solution is saturated. If the solution is supersaturated and no solids are present, there is a region of ion concentrations above the saturated ion concentration that is called a metastable zone as described in Non-Patent Literature Document [2]. In the metastable zone, spontaneous formation of crystallization in the solution is impossible. However, crystal growth can take place in the metastable zone of ion concentrations given trigger mechanisms such as the presence of seed crystals but time is required for the crystal growth. For ion concentrations above this metastable zone, the ions can start precipitating out to form solids even when no seed crystals are present and often the solids called crystals form fairly rapidly. After crystal growth is initiated by adding seed crystals to the unstable supersaturated solution in the metastable zone having no solids present, solids start to precipitate to form crystals and continue to precipitate out into crystals until the saturation condition is reached which consists of both saturated saline water and solids. The rate of precipitation (crystallization) can play a role in forming solids from supersaturated saline water.

### BRIEF SUMMARY OF THE INVENTION

This invention obtains fresh water and only solid waste from input saline water. This result is commonly known as desalination having zero liquid discharge (ZLD). The current common means of ZLD desalination is to use any common desalination process such as distillation, reverse osmosis, electrodialysis, etc. followed by brine recovery and crystallization which are both based on evaporation of water processes. This invention provides an alternative to the commonly used brine recovery and crystallization processes to produce only solid waste. This invention has major components of (a) new ion concentration process, (b) combinations of prior art desalination processes and new ion concentration processes to produce fresh water and nearly saturated saline water from a saline water input, (c) another combination of prior art desalination and new ion concentration processes to produce fresh water and supersaturated saline water having a salinity in the metastable zone from a nearly saturated saline water input, and (d) a separate process that precipitates out solids from the supersaturated saline water having a salinity in the metastable zone after seed crystals are introduced. Each of these processes are briefly discussed.

A base ion transfer process in which prior art electrodialysis and capacitive deionization with recirculation are examples is used as a fundamental element in the ion concentration process. The current common use of the base ion transfer process is to use the less saline output water and reject the more saline output water as waste. In this case, the more saline output water is the desired output. The ratio of the salinities of the more saline output water to the less saline output water is also limited to insure proper operation of the base ion transfer devices. Multiple base ion transfer processes are arranged so that the resultant outputs are nearly saturated saline water and even less saline output water than that of the input saline water. This arrangement is called the ion concentrator.

Multiple prior art desalination processes and ion concentrators are arranged to provide outputs of fresh water and nearly saturated saline water. The nearly saturated saline water is then passed to a precipitative crystallizer that uses combinations of desalination processes and ion transfer processes to produce more fresh water and supersaturated saline water having salinities in the metastable zone. The concentrated saline water having salinities in the metastable zone is passed to a precipitative tank where seed crystals are introduced, solids are formed from precipitation, and the now just saturated saline water is combined with the nearly saturated saline water of the input to the precipitative crystallizer for recirculation. On each new pass, the new nearly saturated saline water passing through the ion concentrator that supersaturate the saline water will dissolve any inadvertent crystallization left from the previous pass so that the crystals will not continue to grow in size as time goes on to foul the ion concentration process that supersaturates the saline water. After any inadvertent formed crystals are dissolved on this new pass, the nearly saturated saline water is then supersaturated for this new pass.

### BRIEF DESCRIPTION OF THE SEVERAL VIEWS OF THE DRAWING(S)

FIG. 1 Prior art ion transfer process using recirculation called the base ion concentrator where examples are electrodialysis and capacitive desalination but with an output limit on the ratio of salinities of the more saline output water to the less saline output water

FIG. 2 Concatenated concentrator composed of concatenated base ion concentrators where the more saline water output of one base ion concentrator feeds the input of the next base ion concentrator and the less saline outputs of all the base ion concentrators are combined

FIG. 3 The ion concentrator is composed of a series of a set of concatenated concentrators where the less saline output water of one set of concatenated concentrators feeds the next set of concatenated concentrators and all the nearly saturated saline water outputs are combined

FIG. 4 The desalinate/concentrate process is illustrated by showing the flow of an input of saline water through a series of desalination processes and ion concentrators producing fresh water and nearly saturated saline water as outputs. All the fresh water outputs are combined and all the nearly saturated saline water outputs are combined

FIG. 5 The precipitative/crystallizer is illustrated by showing the flow of an input nearly saturated saline water through a series of desalination processes and ion concentrators to form fresh water and supersaturated saline water having salinities in the metastable zone which precipitates solids in a separate process after seed crystals are introduced.

### DETAILED DESCRIPTION OF THE INVENTION

This invention obtains fresh water and only solid waste from input saline water where this process is commonly known as desalination having Zero Liquid Discharge (ZLD). Fresh water is defined as mostly pure water with only modest amounts of other contaminants in it and the input saline water is supply water that has been preprocessed leaving only the ions and a low concentration of other contaminants suspended in the water. The current common means of ZLD desalination is to use any common desalination process such as distillation, reverse osmosis, electrodialysis, etc. followed by brine recovery and crystallization which are both based on evaporation of water processes. This invention provides an alternative to the commonly used brine recovery and crystallization processes to produce only solid waste. This invention has major components of (a) new ion concentration process, (b) combinations of prior art desalination processes and new ion concentration processes to produce fresh water and nearly saturated saline water from a saline water input, (c) another combination of prior art desalination and new ion concentration processes to produce fresh water and supersaturated saline water having a salinity in the metastable zone from a nearly saturated saline water input, and (d) a separate process that precipitates out solids from the supersaturated saline water after seed crystals are introduced. Each of these processes are separately discussed.

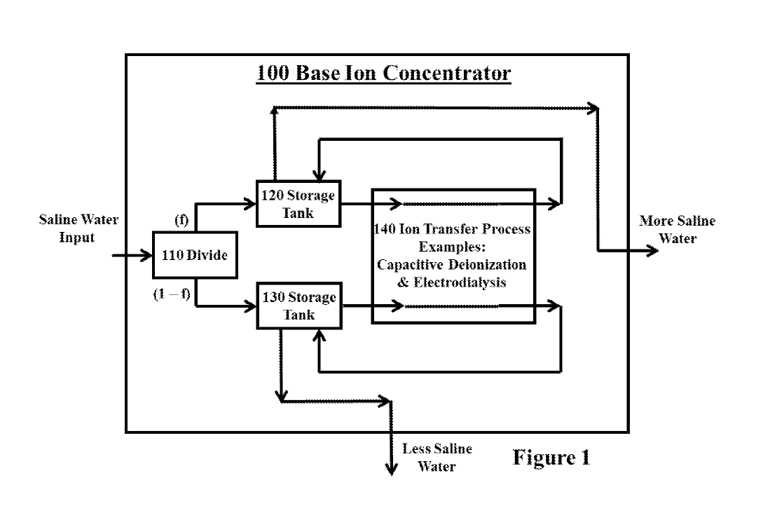

The base ion concentrator 100 is shown in FIG. 1. The base ion concentrator is constructed from prior art deionization processes such as electrodialysis or capacitive deionization processes that use recirculation except in this case: (a) the more saline output water is the output of interest and the less saline water becomes the reject water and (b) the ratio of the salinities of the more saline water to the less saline water is limited to insure a comfortable region of operation. Briefly, the input saline water to the base ion concentrator 100 is divided into two parts by 110, although not necessarily equal parts, and sent to two different storage tanks 120 and 130. The saline water from each storage tank is pumped through the ion transfer process 140 and then returned to the same storage tank that it was initially pumped from. The water in storage tank 120 becomes more saline while the saline water in storage tank 130 become less saline as time goes on. After the ratio of the salinities of the water in each tank reaches a desired threshold, the more saline water, being the desired product, is pumped to the next process and the less saline water, being the reject water, is pumped to the next process for it. Any water contaminants other than ions is unaffected by ion transfer and are passed on through the two output ports in the same ratio as the divider 110.

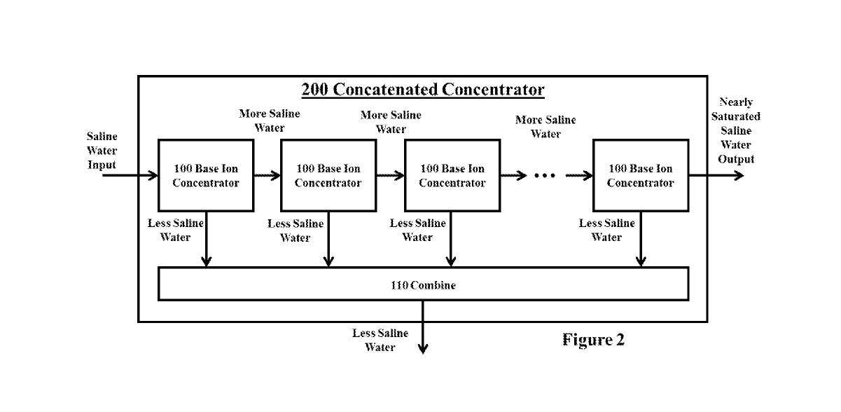

Typically, the single stage base ion concentrator 100 is not sufficient to concentrate the desired more saline water to be nearly saturated saline water. To obtain higher saline water concentrations, multiple base ion concentrators 100 are concatenated in a concatenated concentrator 200 as shown in FIG. 2. The more saline water output from one base ion concentrator 100 is fed into the next base ion concentrator 100 and this process is repeated until the more saline water from the last concatenated base ion concentrator 100 is output as nearly saturated saline water. The less saline water from all the base concentrators 100 are summed in 110 to provide a single less saline water output.

An example of the concatenated concentrator 200 is provided.
Input Water: Saline water made up of 950 kg of fresh water and 50 kg of salt dissolved in the fresh water for a salinity 50 kg/(950 kg+50 kg)=5%
Problem: Concatenate base ion concentrators to provide a more saline water output of about 20% and a less saline output water of less than 5% salinity using base ion concentrators that cannot have a ratio of more saline water salinity to less saline water salinity of more than 5 to 1.
First Base Ion Concentrator: First the input saline water is divided into 2 equal parts yielding 475 kg fresh water and 25 kg of salt dissolved in each storage tank. This base ion concentrator is operated with both separate water paths recirculating until there is 17 kg of salt ions transferred from the less saline water to the more saline water. The salinity of the less saline water then is (25 kg−17 kg)/(475+25 kg−17 kg)=1.65% and the salinity of the more saline water is (25 kg+17 kg)/(475+25 kg+17 kg)=8.12%. The ratio of these two salinities is 4.9 so the imposed limit on the ratio of salinities is satisfied.

Second Base Concentrator: The input saline water from the more saline water from the first base ion concentrator is divided into 2 equal parts yielding 237.5 kg fresh water and (25 kg+17 kg)/2=21 kg of salt dissolved in each storage tank. This base ion concentrator is operated with both separate water paths recirculating until there is 14.5 kg of salt ions transferred from the less saline water to the more saline water. The salinity of the less saline water then is (21 kg−14.5 kg)/(237.5+21 kg−14.5 kg)=2.66% and the salinity of the more saline water is (21 kg+14.5 kg)/(237.5+21 kg+14.5 kg)=13%. The ratio of these two salinities is 4.9 so the imposed limit on the ratio of salinities is satisfied.

Third Base Concentrator: The input saline water from the more saline water from the second base ion concentrator is divided into 2 equal parts yielding 118.75 kg fresh water and (21 kg+14.5 kg)/2=17.75 kg of salt dissolved in each storage tank. This base ion concentrator is operated with both separate water paths recirculating until there is 12.5 kg of salt ions transferred from the less saline water to the more saline water. The salinity of the less saline water then is (17.75 kg−12.5 kg)/(118.75+17.75 kg−12.5 kg)=4.23% and the salinity of the more saline water is (17.75 kg+12.5 kg)/(118.75+17.75 kg+12.5 kg)=20.3%. The ratio of these two salinities is 4.8 so the imposed limit on the ratio of salinities is satisfied.

Combine the Less Saline Outputs from All Base Ion Concentrators: The total fresh water from the less saline water outputs of all of the three base ion concentrators is (475 g+237.5 kg+118.75 kg)=831.25 kg. The total weight of salt dissolved in the fresh water is (8 kg+6.5 kg+5.25 kg)=19.75 kg. The salinity of the less saline output water then is (19.75 kg/(831.25 kg+19.75 kg)=2.3%

Example Summary:
Input Saline water: 950 kg of fresh water with 50 kg of salt dissolved in it (5% salinity)
More Saline Water Output: 118.75 kg of fresh water with 30.25 kg of salt dissolved in it (20.3% Salinity)
Less Saline Water Output: 831.25 kg of fresh water with 19.75 kg of salt dissolved in it (2.3% Salinity)

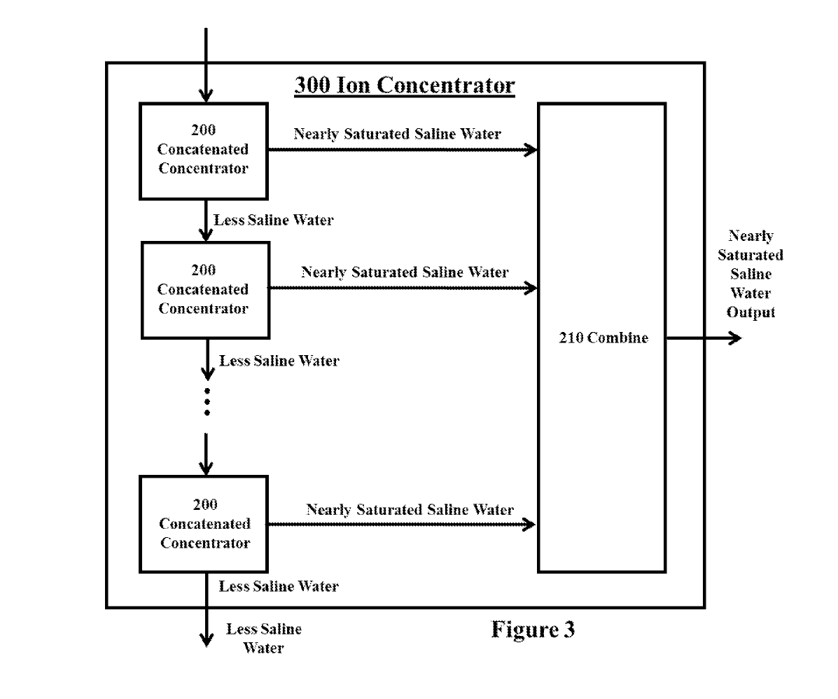

Although the objective of having a nearly saturated saline water output is obtained by the concatenated concentrator 200 shown in FIG. 2, the reject less saline water may not have been reduced in salinity to a desired level for the design of interest. To obtain lower saline water concentrations in the reject saline water, multiple concatenated concentrators 200 are connected in series in an ion concentrator 300 as shown in FIG. 3. The less saline water output from one concatenated concentrators 200 is fed into the next concatenated concentrators 200 and this process is repeated until the less saline water from the last concatenated concentrator 200 is output as even less saline water. The nearly saturated saline water from all the concatenated concentrators 200 are summed in 210 to provide a single nearly saturated saline water output.

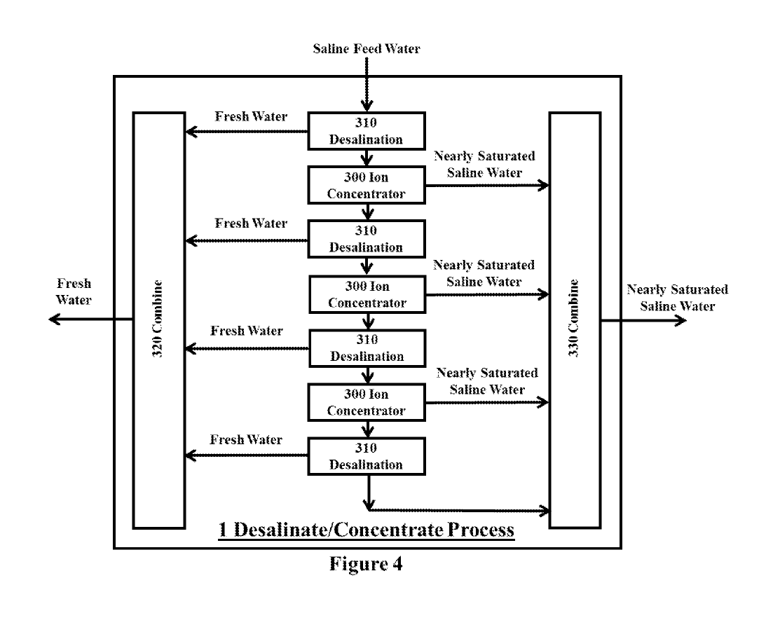

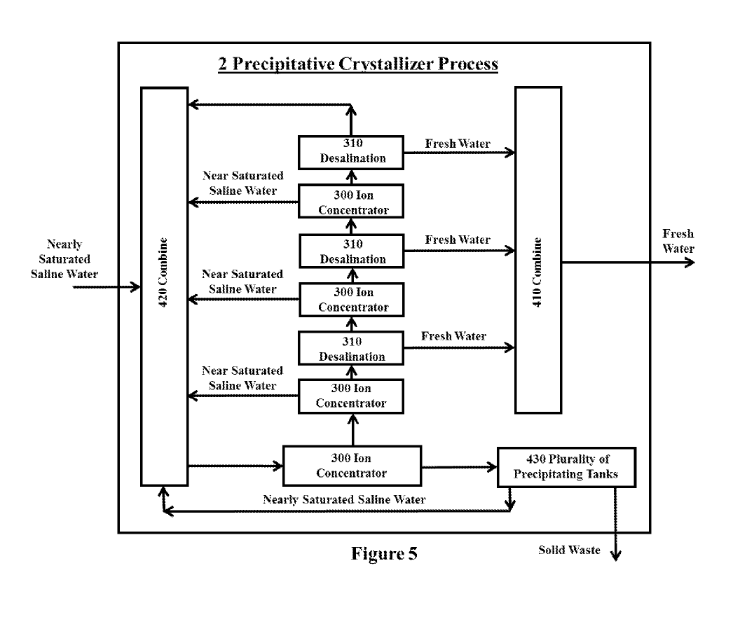

The next part of this invention, defined as desalinate/concentrate process 1 as shown in FIG. 4, combines prior art of desalination processes with the newly configured ion concentrators 300 to produce fresh water and nearly saturated saline water as outputs from a saline water input. The saline water enters a prior art desalination process 310 that outputs fresh water and more saline water. The more saline water is then passed through an ion concentrator 300 which outputs nearly saturated saline water and even less saline water. These two processes are repeated in the same order a number of times until the last process is only a desalination process. The fresh water outputs from all the prior art desalination processes 310 are combined in 320 to form a single fresh water output and the nearly saturated saline water outputs from the new ion concentration processes 300 are combined in 330 to form a single nearly saturated saline water output. Note the output more saline water from the last desalination process 310 is not saturated but since it represents only a small amount of water, the nearly saturated saline water from 330 remains nearly saturated saline water. An alternative is to simply pass the output from the last desalination process 310 through a traditional evaporative crystallization process. This can be cost effective because there is so little saline water to process.

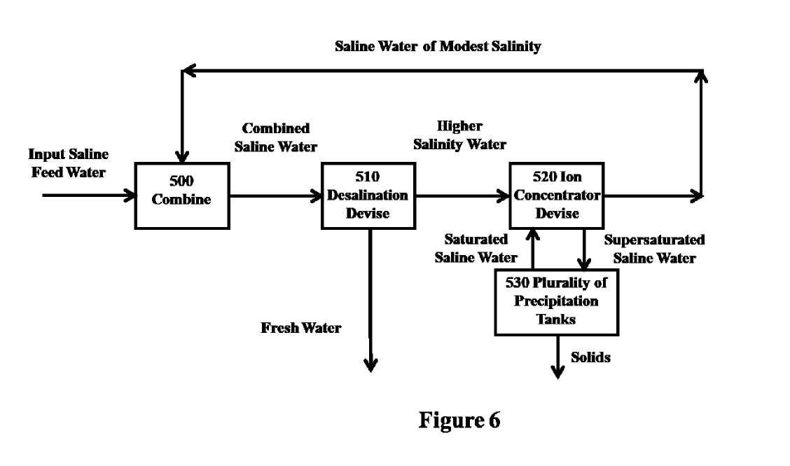

The next part of this invention, defined as precipitative crystallizer process 2 as shown in FIG. 5, combines prior art of desalination processes, newly configured ion concentrators 300, and a plurality of precipitation tanks to produce fresh water and solid waste as outputs from a nearly saturated saline water input. The nearly saturated saline water input water passes through a combiner 420 and into a first ion concentrator process 300 that outputs supersaturated saline water having a salinity in the metastable zone, which is subsequently discussed, and less saline water. The less saline water from this first ion concentrator 300 is passed through a second ion concentrator which outputs nearly saturated saline water and even less saline water which is then passed onto a prior art desalination process 310. The processes of ion concentration 300 operating on less saline water, and prior art desalination 310 operating on even less saline water are repeated multiple times. The fresh water outputs from all the prior art desalination processes 310 are combined in 410 to form a single fresh water output and the nearly saturated saline water outputs from the ion concentration processes 300 are combined in 420 to form a single nearly saturated saline water output which is then fed back to the first ion concentrator 300.

Backtracking now to the supersaturated saline water being formed in the very first ion concentrator 300 of the precipitative crystallizer 2, this supersaturated saline water is output to one of a plurality of precipitative tanks 430 after the salinity has reached a metastable zone threshold where spontaneous precipitation would occur. Seed crystals are applied to the supersaturated saline water in the precipitation tank 430 and solids precipitate out. After this precipitation process is complete, the now only saturated saline water is filtered to remove any suspended precipitated solids and then combined with the other nearly saturated saline water in combiner 420. The solids can be disposed of as waste. To determine if the salinity of the supersaturated saline water is at the metastable zone threshold, measurements of the concentrations of the ions can be made and with a smart processor one can determine if a cation and anion combination is at the metastable zone threshold for that combination. Alternately, one can detect if precipitation has begun by looking for particles starting to appear in the supersaturated water. It is critical that little precipitation of solids occur while the supersaturated saline water is being formed so as to not foul the processes. Even if a small quantity of solids inadvertently form during a first ion concentration process 300, on the next pass of receiving nearly saturated saline water, these solids will dissolve early in the process while the feed water is still slightly unsaturated before this small quantity of solids could grow larger when the nearly saturated saline water is supersaturated. This operation and fact is critical to the success of the precipitative crystallizer 2.

If there are small quantities of other suspended contaminants other than ions in the input saline water, a small quantity of these could end up in the fresh water ports. However, most of the small quantities of suspended contaminants other than ions in the input saline water will end up in the precipitation tank. The filter that filters the saturated saline water containing suspended precipitated solids will also filter out these other contaminants other the ions and keep them in the precipitation tank. These other non-ionic contaminants as well as the precipitated-out solids can then be removed for disposal.

All the processes in the ion concentrators 300, desalinate/concentrate process 1, and precipitative crystallizer process 2 can be implemented in a different manner but achieve the same results. A plurality of (a) base ion concentrator processes, (b) desalination processes, (c) storage tanks, and (d) combiners, defined in the concentrators 300, desalinate/concentrate process 1, and precipitative crystallizer process 2, can be made available. Under the control of a smart controller not shown, the saline water can be shifted between any available base ion concentrator, any available desalination process, any available storage tank, and any combiner to process the saline water so that the end result is the same as shown in the processes defined by ion concentrators 300, desalinate/concentrate process 1, and precipitative crystallizer process 2.

1-6. (canceled)

7. A saline water desalination and concentration process composed of:
a. any deionization devise such as electrodialysis, capacitive deionization, and capacitive electrodialysis that transfers ions between two independent saline waters which can greatly increase the salinity of one of the saline waters and reduce the salinity of the other saline water where it's significant property is that it can highly concentrate the one saline water and leave the other saline water with lower but yet significant salinity;
b. the said deionization devise can be composed of a set of said concatenated similar said deionization devises;
c. any desalination devise such as reverse osmosis that can greatly reduce the salinity of a large portion of saline water but leave a significant portion of the remaining water with higher salinity where its significant property is the higher salinity water can't obtain very high salinities although the desalinated water can be very low in salinity and can even be called “fresh water”;
d. the said saline water desalination and concentration process cascades alternate said desalination devises and said deionization devises in a sequential string of operations such that the first said desalination device provides “fresh water” and some saline water of higher salinity than the feed water, then a said deionization devise transfers ions from its input saline water to another independent saline water and its original now reduced salinity saline water is transferred to a second said desalination devise which outputs said “fresh water” and some saline water of higher salinity than its feed water to a second said deionization devise, which transfers ions from its input saline water to another independent saline water and its original now reduced salinity saline water is transferred to a third said desalination devise, which outputs said “fresh water” and some saline water of higher salinity than the feed water to a third said deionization devise, and so forth using cascaded alternate said desalination and deionization devices until there is little saline water yet to be processed;
e. an alternate but equivalent said saline water desalination and concentration process of claim 1d is to use only one said desalination devise and one said deionization devise along with multiple storage tanks where a controller transfers saline waters between a said desalination devise, a said deionization devise, and multiple storage tanks such as to obtain the same resulting process described in claim 7d;
f. all the “fresh water” and all the concentrated very high salinity water from the cascaded desalination and deionization devises obtained in claims 7d or 7e are respectively collected so that there is only one “fresh water” output and one concentrated very high salinity water output from the process; and
g. another alternate said saline water desalination and concentration process but equivalent in results to that of claim 7d or claim 7e, is to use only one said desalination devise and one said deionization devise whereas a single said desalination devise provides “fresh water” and some saline water of higher salinity than its feed water to the single said deionization devise which then transfers ions from its input saline water to another independent saline water and its original now reduced salinity saline water is transferred back to the beginning of the process and combined with the input saline feed water of the said saline water desalination and concentration process which has the same type of effect as the process of cascading a string of multiple alternating said desalination and said desalination devises as described in claim 7d because it provides a mechanism for a decreasing amount of the input saline water to pass through the single said desalination devise and single said deionization devise multiple times as described in claim 7d and furthermore, the end result is the same because it provides outputs of only “fresh water” and highly concentrated saline water as also stated in claim 7f.

8. A crystallization process using the said saline water desalination and concentration process of claim 7 is:
a. the said saline water desalination and concentration process of claim 7 is performed long enough in time for the independent saline water that the ions are being transferred into within the said deionization devise to become supersaturated but yet this independent saline water resides in a metastable state where no spontaneous precipitation can occur;
b. before the independent supersaturated saline water that resides in the metastable state within the said deionization devise becomes so supersaturated that spontaneous precipitation would occur, the independent supersaturated saline water is transferred to storage containers where seed crystals are introduced and the saline water is held for long enough time for precipitation to occur in which solids are formed; and
c. after the independent saline water salinity located in the said storage containers is reduced to saturation levels due to the precipitation, the now saturated independent saline water is filtered to remove any precipitated solids that may yet be suspended in the saturated saline water and then mixed back with the independent saline water circulating in the said deionization devise.
